(19) United States
(12) Patent Application Publication
(10) Pub. No.: US 2009/0110766 A1
(43) Pub. Date: Apr. 30, 2009

(54) Coupling for Pelleting Mill

(75) Inventors: Kelsey C. Thom, JR., Cedar Falls, IA (US); Odd Maarten Visser, Hilversum (NL)

Correspondence Address: SQUIRE, SANDERS & DEMPSEY L.L.P., 1 MARITIME PLAZA, SUITE 300, SAN FRANCISCO, CA, 94111, US

(73) Assignee: CPM Acquisition Corporation, Waterloo, IA (US)

(21) Appl. No.: 12/257,705

(22) Filed: Oct. 24, 2008

Related U.S. Application Data
(60) Provisional application No. 60/982,673, filed on Oct. 25, 2007.

(51) Int. Cl. B29C 67/02

(52) U.S. Cl. 425/222

(57) ABSTRACT

A pelleting die assembly includes a tubular die that is rotated by a quill flange. During rotation, particulate material inside the tubular die is extruded through extrusion holes by rollers inside the tubular die. The die is coupled to the quill flange by a flat, annular disc having one side attached to the die by bolts and an opposite side attached to the quill flange by other bolts. The bolts extend axially through the annular disc and face in opposite directions. The annular disc may include grooves to allow cyclic deflection of the die in a radially outward direction while reducing cyclic loading and strain on the quill flange.

This application claims the benefit of U.S. Provisional Application No. 60/982,673, filed Oct. 25, 2007.

### FIELD OF THE INVENTION

This invention relates generally to pelletizing machinery and, more particularly, a pellet mill and pellet die assembly for pelletizing particulate materials.

### BACKGROUND OF THE INVENTION

Pellet mills are used to form a variety of pellet products, such as pelletized animal feed, from mash product composed of various grains or other particulate material. The particulate material is extruded through extrusion holes in a rotating die. As shown in FIG. 1, extruded product 2 that exits the die 4 may be sheared off by blades 6 on the outer surface of the die. Eventually, the die 4 must be replaced due to wear caused by abrasion from the particulate material 8 and/or rollers 9 inside the die. It may also be desirable to replace the die when a different type of particulate material is used or when different pellet sizes are to be produced. For example, the composition of the particulate material and the desired pellet size may require that a particular extrusion hole diameter and length be used.

In conventional pellet mills, particulate material is introduced in one end of the die, which is rotated by a flange at the end of a shaft, known as a “quill.” The quill is typically tubular in that it has a central opening that contains a stationary shaft, known as a “mainshaft.” The mainshaft is used to carry the rollers inside the die which force the particulate material through the extrusion holes.

Various devices have been used to couple the die to the quill. One type of device involves a v-clamp, such as shown in FIG. 2. The v-clamp 10 consists of multiple angled segments made of cast or forged steel which are bolted to the quill flange 12 and held in a radial position against tapered portions 14, 16 of the quill and die 18, thus clamping the tapered portions together. Another type of device involves a bolted taper joint, such as shown in FIG. 3. The taper joint consists of a tapered ring 20 wedged between the pilot 22 of the quill flange 12 and the tapered pilot 24 of the die 18. The pilots 22, 24 are held together by bolts 26 accessible from the rear end of the quill flange. Both the v-clamp and taper joint designs rely on tapered fits where the bolts maintain a wedge-like connection between tapered surfaces. The torque applied to the bolts is limited to avoid severely locking the tapered surfaces. Since the bolts cannot be torqued to their maximum values they are very susceptible to breakage if part wear or part tolerances are not monitored closely.

The process of extruding the particulate material through the die 18 creates tremendous resistance to rotation by the quill 12. As such, the v-clamp (FIG. 2) is typically massive in size and weight, making them expensive and difficult to physically handle when replacing the die. As for the bolted taper joint design (FIG. 3), the tapered cylinder 20 is positioned axially or parallel the quill and die rotational axis or centerline, making it difficult to align and mount the die to the quill. Also, the die is engaged with tapered cylinder at a relatively small contact area. Limited bolt accessibility is another problem with conventional designs that makes it difficult to use conventional torque wrenches when removing and reinstalling the die.

Accordingly, there is a need for a pellet mill and die assembly having a convenient and cost-effective means of replacing the die. There is also a need for a coupling device that facilitates alignment of the die on the quill, is capable of handling tremendous resistance to rotation, and allows easier access to bolts to allow efficient removal and reinstallation of the die.

### SUMMARY OF THE INVENTION

Briefly and in general terms, the present invention is directed to a pellet mill and a pelleting die assembly.

In aspects of the present invention, a pelleting die assembly is capable of being mounted on a quill of a pellet mill. The assembly comprises a die including an end surface for facing the quill, a coupling member removably attached to the end surface, and an attachment device extending through the coupling member, the attachment device for attaching the coupling member to the quill.

In other aspects of the present invention, a pellet mill assembly comprises a quill, a die, and a coupling device connecting the die and the quill. The coupling device includes a coupling member and an attachment device, the coupling member including a quill facing surface, the attachment device extending through the coupling member and pushing the quill facing surface into contact with the quill.

In further aspects of the present invention, a pelleting die assembly comprises a die, a coupling ring, and an attachment device. The die includes a tubular wall defining a chamber inside the die, the tubular wall having two opposite ends, an inner surface, an outer surface, and a plurality of holes extending through the tubular wall. The ring is removably attached to one of the opposite ends of the die, the ring having a first circumferential region and a second circumferential region surrounding the first circumferential region, the first circumferential covered by the die, the second circumferential region extending radially outward from the outer surface of the die. The attachment device extends axially through the second circumferential region.

The features and advantages of the invention will be more readily understood from the following detailed description which should be read in conjunction with the accompanying drawings.

### BRIEF DESCRIPTION OF THE DRAWINGS

FIG. 1 is a front, cross-sectional view of a pelleting die assembly showing rollers and blades on the inner and outer surfaces of a rotating die.

FIG. 2 is side, cross-sectional view of a portion of a pelleting die assembly showing a v-clamp connecting a die to a quill.

FIG. 3 is side, cross-sectional view of a portion of another pelleting die assembly showing a tapered joint connecting the die to a quill.

FIG. 4 is side, cross-sectional view of a pelleting machine showing a feeder housing connected to a die pelleting assembly.

FIG. 5 is side, cross-sectional view of another pelleting machine showing a die rotated by an offset drive shaft.

FIG. 6 is perspective view of pelleting die assembly.

FIG. 7 is an exploded, perspective view of the pelleting die assembly of FIG. 6

FIG. 8 is an exploded, cross-sectional view of the pelleting die assembly of FIG. 6.

FIG. 9 is a side, cross-sectional view of a portion of a pelleting die assembly showing a coupling ring adapted accommodate radial deflection of a die.

FIG. 10 is a front view of a pelleting die assembly showing a coupling ring with drive keys attached to a quill flange.

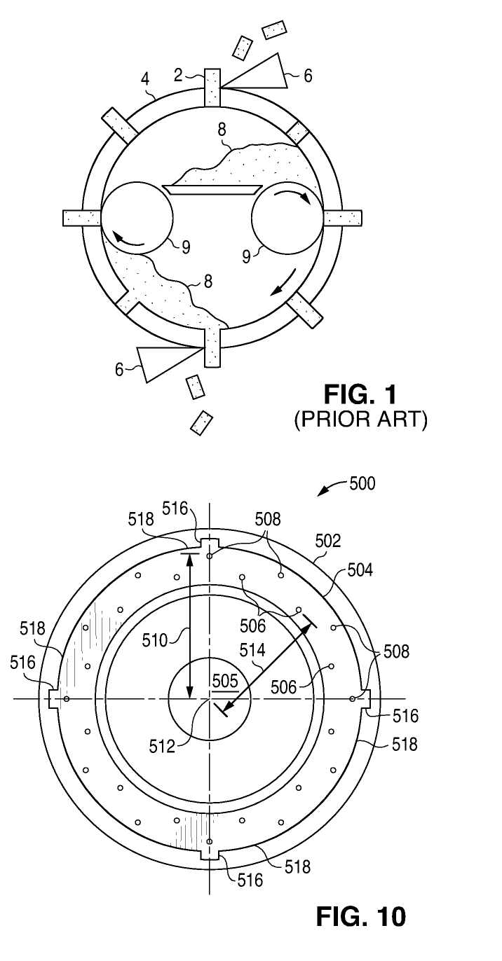

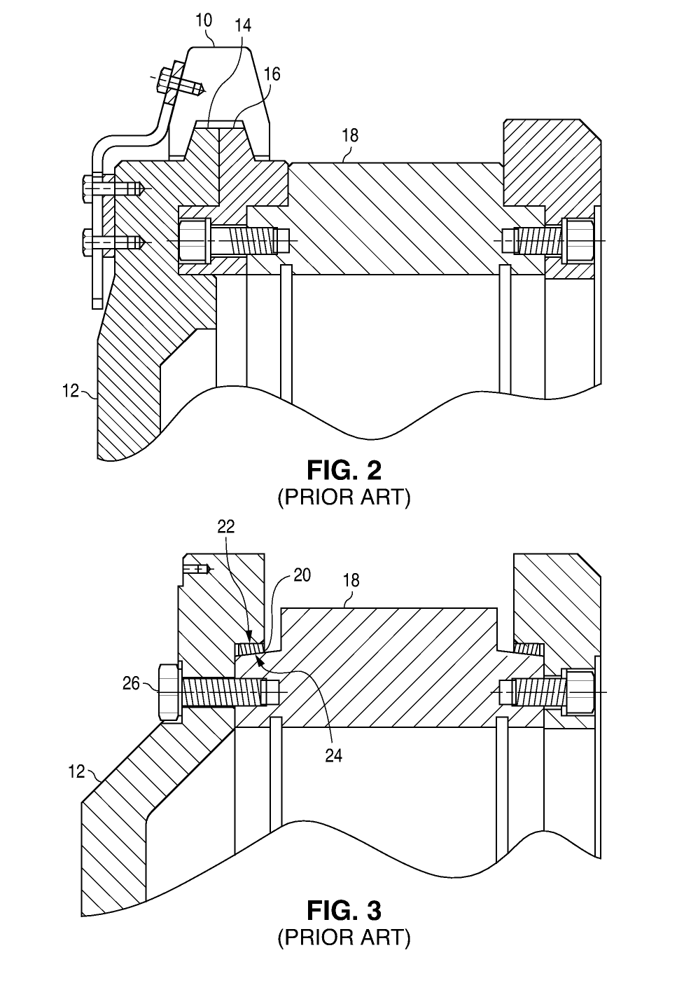

### DETAILED DESCRIPTION OF THE INVENTION

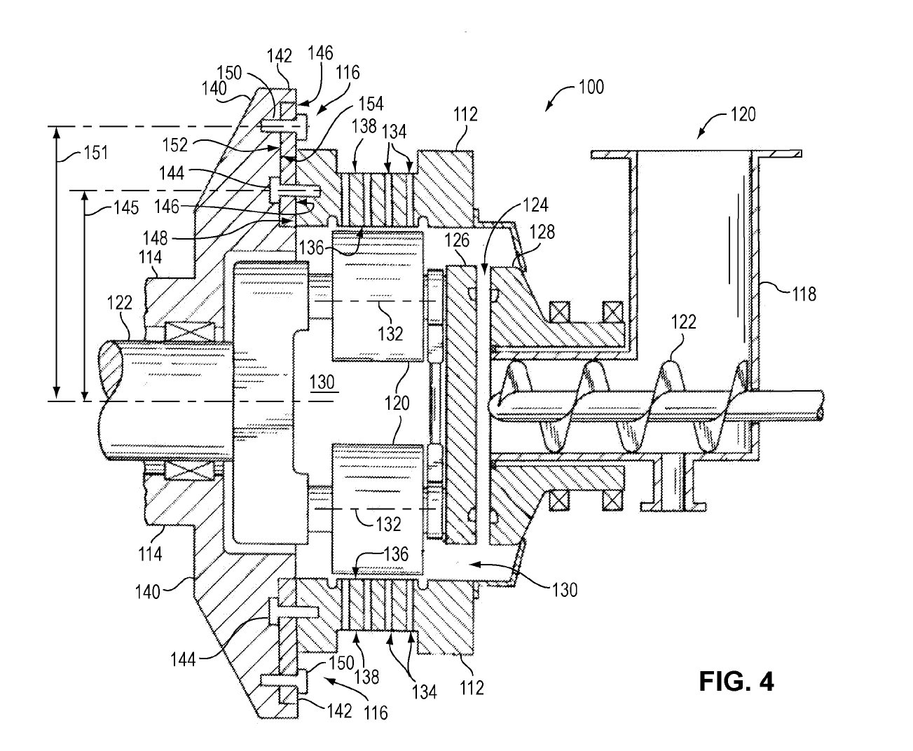

Referring now in more detail to the exemplary drawings for purposes of illustrating embodiments of the invention, wherein like reference numerals designate corresponding or like elements among the several views, there is shown in FIG. 4 a pelleting machine 100 having a convenient and cost-effective means of replacing a pelleting die 112. The die is attached to a quill shaft 114 by a coupling device 116 that facilitates alignment of the die on the quill, is capable of handling tremendous resistance to rotation, and allows easier access to mounting bolts as compared to conventional coupling means.

Adjacent the front end of the die 112 is a feeder housing 118 that provides mash, feed product, or particulate material to the die. Particulate material enters a top inlet 120 of the feeder housing 118 and is driven by a screw feeder 122 into a gap 124 between a circular plate 126 and a rotating shear plate 128. Rotation of the shear plate 128 urges the particulate material out from the periphery of the two plates 126, 128, where it enters the central opening 130 of the die 112.

Cylindrical rollers 120 are held in the central opening 130 by a stationary mainshaft 122 that extends through the quill shaft 114. The rollers are mounted such that they rotate about their respective central axes 132 while the quill 114 and die 112 rotate about the main central axis 155. Rotation of the die and the rollers cause the particulate material to push through a number of holes 134 extending through the die from the inner surface 136 of the die to the outer surface 138. There may be stationary blades (not shown) on the outer surface of the die for cutting extruded particulate material to form pellets of a desired size.

Still referring to FIG. 4, the die is 112 is coupled to a quill flange 140 that extends radially outward from the quill shaft 114. A coupling member 142 is disposed between the die 112 and the quill flange 140. An attachment device in the form of a first set of bolts 144 attaches a forward facing surface 146 of the coupling member 142 into contact with a rear end surface 148 of the die 112. Another attachment device in the form of a second set of bolts 150 attaches a rear facing surface 152 of the coupling member 142 into contact with a front surface 154 of the quill 140.

The first and second set of bolts 144, 150 are radially offset from each other. The first set of bolts 144 is located at a first radius 145 on the coupling member 142. The second set of bolts 150 is also located on the coupling member, but at a second radius 151 that is greater than the first radius. The second radius is selected so that the bolt heads of the second set of bolts 150 are clear of and unobstructed by the die 112. The first and second radii 145, 151 corresponds to the distances from the central axis 155 of the quill and die to the central axis of the bolts 144, 150.

The first set of bolts 144 have threads which engage threads in the die 112. The coupling member 142 is urged into contact with the rear end surface 148 of the die 112 as each bolt 144 is rotated in a tightening direction. Also, the second set of bolts 150 have threads which engage threads in the quill flange 140. The coupling member 142 is urged into contact with the forward surface 154 of the quill flange as each bolt 150 is rotated in a tightening direction.

The compression surfaces 146, 148 of the coupling member 142 and the die 112 are flat and perpendicular to the rotational axis 155 of the die and quill 140. The first set of bolts 144 may be tightened up to or just below their ultimate strength so as to maximize compression at the contact interface defined by the compression surfaces 146, 148. Maximizing compression also maximizes frictional engagement between the coupling member 142 and the die 112 and minimizes shear stress on the bolts 144.

The compression surfaces 152, 154 of the quill 140 and the die 112 are also flat and perpendicular to the rotational axis 155 of the die and quill. The second set of bolts 150 may be tightened up to or just below their ultimate strength so as to maximize compression at the contact interface defined by the contacting surfaces 152, 154. Maximizing compression in turn maximizes frictional engagement between the coupling member 142 and the quill 140 and minimizes shear stresses on the bolts 150.

The compression surfaces 146, 152 of the coupling ring 142 are greater in area than the compression surfaces of the tapered ring 20 of FIG. 3. In FIG. 3, the tapered ring 20 is small compared to the coupling ring 142 because the tapered ring 20 is confined in a space radially between compression surfaces of the die and the quill. By comparison, the coupling ring 142 is located axially between compression surfaces 148, 154 of the die and the quill, which allows the coupling ring 142 to have larger compression surfaces and, thereby, provide greater frictional engagement than the tapered ring 20 of FIG. 3.

Referring again to FIG. 4, the die 112 is removable from the pelleting machine 100 to allow for cleaning, maintenance, or replacement due to deterioration of the extrusion holes 134 and/or the work surfaces 136, 138 of the die. Also, a change in the composition of the particulate material may require use of a different die having extrusion holes of a particular diameter and length. To remove the die 112, the second set of bolts 150 are removed, which allows the coupling member 142 and the die 112 to be pulled forward and away from the quill flange 140. Next, the first set of bolts 144 are removed, which allows the coupling member to be separated from the die so that the coupling member can be used again.

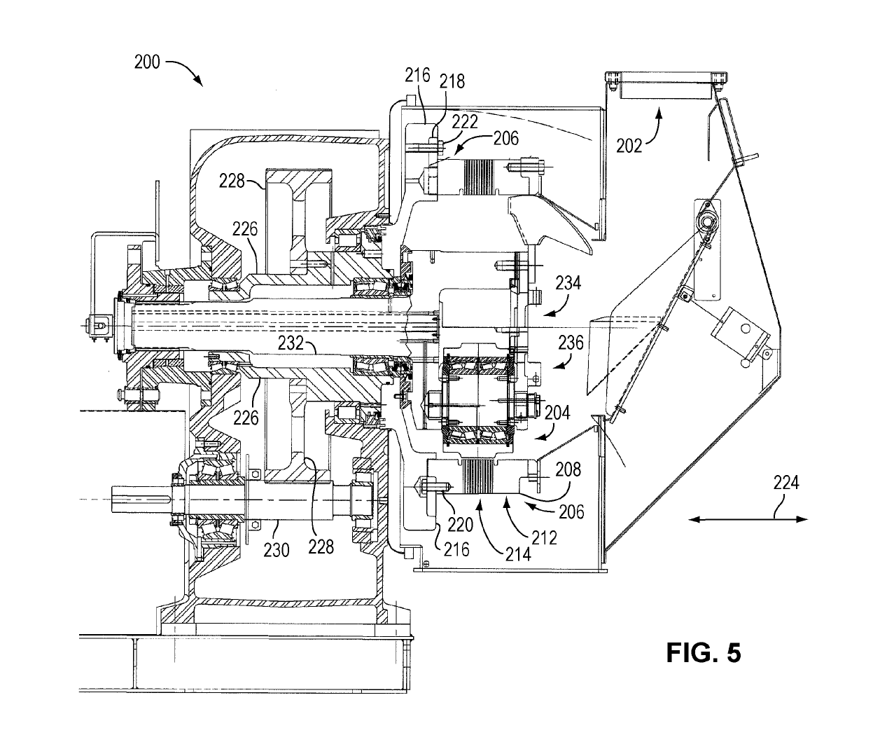

FIG. 5 shows a pelleting mill 200 having a top opening 202 for receiving material that is to be made into pellets. The material enters a chamber 204 of a tubular, ring-shaped die 206. The die has a tubular wall 208 that surrounds the chamber, an inner surface 210 on one side of the wall and defining a boundary of the chamber, and an outer surface 212 on the opposite side of the wall. A plurality of extrusion holes 214 are formed through the wall and extend from the inner surface 210 to the outer surface 212.

The die 206 is coupled to a quill flange 216 by a coupling ring 218 and two sets of bolts 220, 222 extending in opposite axial directions 224 through the coupling ring. One set of bolts 220 removably connects the coupling ring 218 to the die 206. Another set of bolts 222 removably connects the coupling ring 218 to the quill flange 216. The quill flange 216 is attached to a quill shaft 226, which is attached to a drive wheel 228. A drive shaft 230 is rotatably engaged with the drive wheel, so that rotation of the drive shaft causes the die 206 to rotate. A mainshaft 232 is disposed inside the quill shaft 226 and extends through the quill flange 216. An armature 234 is connected to the mainshaft and carries roller assemblies 236 inside the chamber 204.

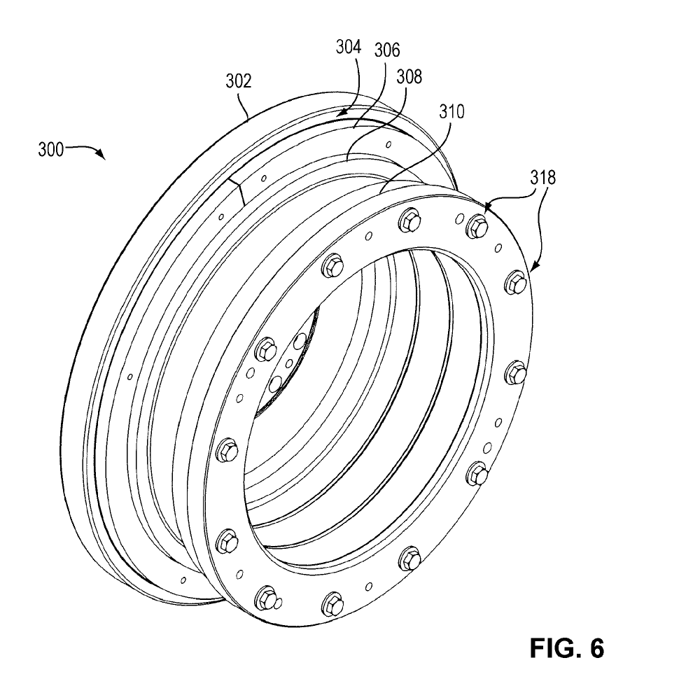

FIGS. 6-8 show a pelleting die assembly 300 in accordance with some embodiments of the present invention. The assembly comprises a quill flange 302 and a die subassembly 303. The die subassembly comprises a coupling ring 304, a cover ring 306, a pellet die 308, and a stiffening ring 310. The quill flange 302 and coupling ring 304 are on the rear side 312 of the pellet die 308, while the stiffening ring 310 are on the opposite, front side 314 of the pellet die. The quill flange 302, the coupling ring 304, and the stiffening ring 310 provide rigidity at opposite sides of the die 308.

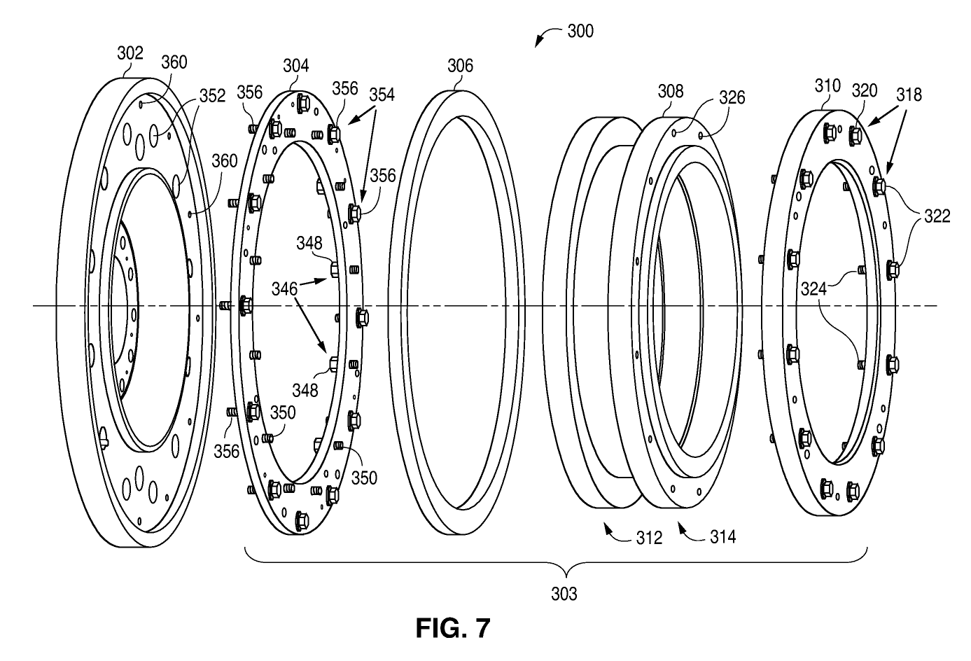

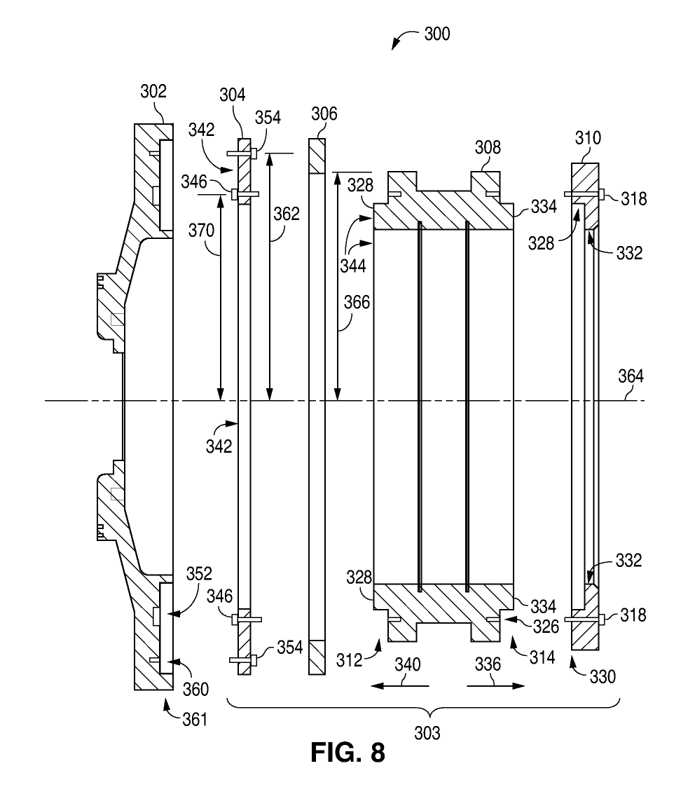

The stiffening ring 310 is attached to the die 308 by bolts 318 and washers 320 arranged circumferentially around the entire stiffening ring. The head 322 on each bolt is accessible from the front end (right hand side in FIGS. 7 and 8) of the assembly 300 and the threaded body 324 of each bolt is engaged with threaded holes 326 in front side 314 of the die. A recess 328 (FIG. 8) is formed into the rear facing side 330 and inner surface 332 of the stiffening ring. The recess 328 matingly receives a forward pilot or shoulder 334 that extends in a forward axial direction 336 from the front side of the die.

The die 308 also includes a rearward pilot or shoulder 338 (FIG. 7) that extends in a rearward axial direction 340 from the rear side 312 of the die. The coupling member 304 rests over the rearward shoulder such that a flat rearward facing surface 342 of the coupling member is parallel to and aligned with the rear end surface 344 of the die.

Still referring to FIGS. 6-8, the coupling ring 304 is attached to the die 308 by die bolts 346 arranged circumferentially around the entire coupling ring. The head 348 on each die bolt is accessible from the rear end of the die subassembly 303 and the threaded body 350 of each die bolt is engaged with threaded holes in the rear side 312 of the die. There are recesses 352 sized to receive the bolt heads formed in the forward side 354 of the quill flange 302.

The coupling ring 304 is attached to the quill flange 302 by quill bolts 354 arranged circumferentially around the entire coupling ring. The head 356 on each quill bolt 354 is accessible from the front end of the die subassembly 303 and the threaded body 358 of each quill bolt is engaged with threaded holes 360 in the forward side 361 of the quill flange. The heads 356 of the quill bolts are located at a radius or radial position 362 relative to the central axis 364 that is greater than or beyond the radius or radial position 366 of the outer surface 368 of the die 308. The position of the quill bolts 354 relative to the outer surface of the die allows for easy access to the quill bolts from the front end of the assembly 300. By comparison, the heads 348 of the die bolts 346 are located at radius or radial position 370 that is less than or below the radius or radial position 366 of the outer surface 368 of the die 308.

The die 308 may be removed from the assembly 300 and replaced as necessary. The coupling ring 304 and stiffening ring 308 may be used again with the new die. To remove the die 308, the die subassembly 303 is separated from the quill flange 302, which may be accomplished by first removing the stiffening ring 310. The stiffening ring bolts 322 may be loosened from the front end of the assembly 300 until the stiffening ring 310 detaches from the die 308. Next, the cover ring 306 may be removed to expose the quill bolt heads 356 which are also accessible from the front end of the assembly 300. A wrench may be used to loosen the quill bolts 354 until the die subassembly 303 detaches from the quill flange 302. Thereafter, the die 308 and the coupling ring 304 may be disconnected from each other by loosening the die bolts 346. The procedure may be reversed to install a new die in the assembly 300.

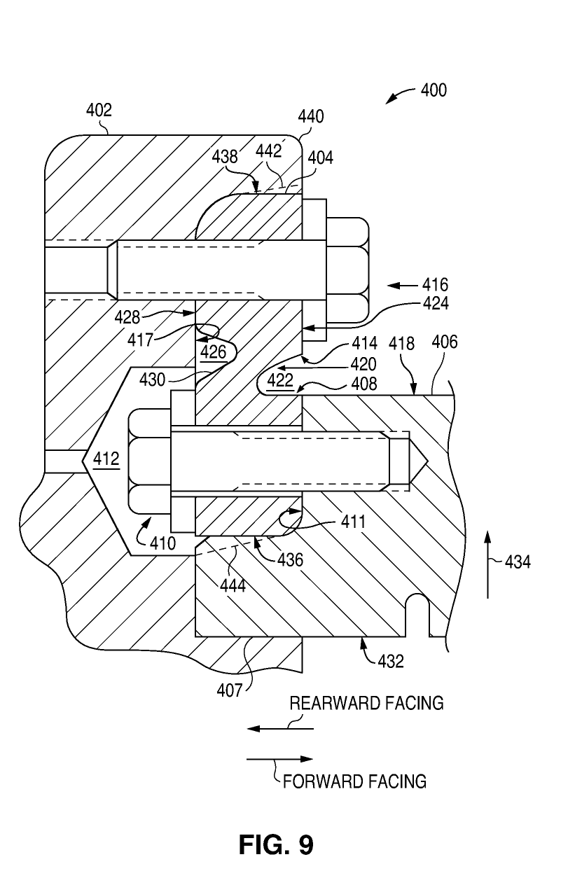

FIG. 9 shows a portion of a pelleting die assembly 400 in accordance with further embodiments of the present invention. The assembly comprises a quill flange 402, a coupling ring 404, and a ring-shaped pellet die 406.

The coupling ring 404 includes first portion 408 that it connected to the die 406 by a first set of bolts 410, referred to as die bolts, which extend axially through the first portion and into the die. The first portion 408 extends circumferentially round the entire coupling ring. The die bolts fixedly clamp the first portion onto a rearward facing surface 411 at the rear end of the die 406. The rearward facing surface 411 extends circumferentially around entire the die 406, is flat, and is perpendicular or substantially perpendicular to the rotational axis of the die 406. The die bolts 410 are tightened to an extent that the rearward facing surface 411 frictionally engages the first portion 408 so that there is no rotational slippage or relative movement between the first portion and the die. In some embodiments, the die bolts 410 are tightened up to or just below their ultimate strength in order to maximize frictional engagement between the first portion 408 and the die 406.

The head of the quill bolt and a washer between the head and the coupling ring 404 are disposed in a circular recess 412 formed into a forward facing surface 417 at the front end of the quill flange 402. The die 406 includes a pilot or shoulder portion 407 that extends axially at a radial position directly below the first portion 408 of the coupling ring 404. In FIG. 9, the term “axial” corresponds to a horizontal orientation or direction and the term “radial” corresponds to a vertical orientation or direction. The shoulder portion 407 partially defines a boundary of an annular recess in the end of the die 406. The annular recess extends circumferentially around the entire die 406 and is sized to receive the first portion 408 of the coupling ring 404.

The coupling ring 404 also includes a second portion 414 that is connected to the quill flange 402 by a second set of bolts 416, referred to as quill bolts, which extend axially through the second portion and into the quill flange. The quill bolts 416 are located at a radial position above the die bolts 410 and the outer surface 418 of the die 406 such that the quill bolts are exposed and accessible from the front (right hand side in FIG. 9) of the pelleting die assembly 400. The second portion 414 extends circumferentially round the entire coupling ring 404. The quill bolts 416 are tightened to an extent that the forward facing surface 417 of the quill flange 402 frictionally engages the second portion 414 so that there is no rotational slippage or relative movement between the second portion and the quill flange. In some embodiments, the quill bolts 416 are tightened up to or just below their ultimate strength in order to maximize frictional engagement between the second portion 414 and the quill flange 402.

During operation, the die 406 experiences cyclic loading as the die rotates relative to the rollers inside the die. Portions of the die 406 at an angular position close to the rollers experience greater loads than portions of the die at an angular position between the rollers. Cyclic loading may cause mechanical fatigue in other parts of the pelleting die assembly 400 and loosening of connections. To minimize these and other negative effects of cyclic loading, the coupling ring 404 includes a medial portion 420 that is relatively flexible as compared to the first and second end portions 408, 414. The medial portion connects the first and second portions together and is adapted to allow the first and second portions to move relative to each other.

In the illustrated embodiment of FIG. 9, the medial portion is defined in part by two annular grooves that extend circumferentially around the entire coupling ring 404 on opposite sides of the coupling ring. The annular grooves allow radial compression of the coupling ring 404 between the shoulder portions 407, 440 of the die 406 and the quill flange 402. A first groove 422 is located immediately above the first portion 408 and is formed into the forward facing side 424 of the coupling ring. A second groove 426 is located immediately below the second portion 414 and is formed into the rearward facing side 428. Also, the second groove 426 is located at a radial position that is above first groove 422 so as to form a flexible linkage 430 between the first and second portions 408, 414.

As particulate material is squeezed between the rollers and the inner surface 432 of the die 406, portions of the die at and around the rollers experience loading and strain in a radially outward direction 434. The strain causes the die to deflect outward where the rollers are located inside the die, which causes the die to have an slightly oblong or oval shape. To minimize strain on the quill flange 402 and avoid loosening of connections, the linkage 430 is adapted to allow the first portion 408 to move radially outward and closer to the second portion 424 during periods of relatively high strain on the die 406. Subsequently, during periods of relatively low strain, the linkage 430 allows the first portion to return to its previous position.

Still referring to FIG. 9, a first axially oriented interface is formed by an inner surface 436 of the coupling ring 404 and the shoulder portion 407 of the die 406. A second axially oriented interface is formed by the outer surface 438 of the coupling ring and a shoulder portion 440 of the quill flange 402. The first and second interfaces extend in a circle, forming concentric cylinders.

In other embodiments, the first and second interfaces are tapered such as shown by dotted lines 442, 444. The dotted lines represent edges of the shoulder portions of the die 406 and quill flange 402. The inner and outer surfaces 436, 438 of the coupling ring 404 may also be tapered at the same or different taper angle. The tapered interface at the shoulder portion 407 of the die 406 is adapted to center the coupling ring 404 on the die 406 when mounting the coupling ring on the die. The tapered interface at the shoulder portion 440 of the quill flange 402 is adapted to center the coupling ring 404 on the quill flange 402 when mounting onto the quill flange 402. In further embodiments, the tapered interfaces are adapted to allow the coupling ring to wedge tightly onto the die and the quill flange.

FIG. 10 shows a portion of pelleting die assembly 500 in accordance with some embodiments of the present invention. The assembly comprises a quill flange 502 and a coupling ring 504. The die is not shown so as to expose the entire front face of the coupling ring. The quill flange 502 has a center hole 505 sized to allow a mainshaft (not shown) to extend therethrough. The coupling ring 504 is shown in front of the quill flange 502 and includes two sets of holes formed through the coupling ring 504.

A first set of holes 506 is circumferentially distributed around the entire coupling ring 504 and is aligned to allow an attachment device (not shown) to extend through the holes 506 and into engagement with the die (not shown). A second set of holes 508 is circumferentially distributed around the coupling ring 504 and is aligned to allow another attachment device (not shown) to extend through the holes 508 and into the engagement with the quill flange 502. The second set of holes 508 are located at a radial distance 510 from the center 512 of the coupling ring 504 that is greater than the radial distance 514 at which the first set of holes 506 are located.

The coupling ring 504 includes four driving key members 516 that protrude radially outward from the circular outer edges 518 of the coupling ring. The driving key member 516 matingly engage a recess formed into a forward facing surface of the quill flange 502. The recess has a shape corresponding to the shape of the driving key members 516. The driving key members 516 ensure that the coupling ring does not slip relative to the quill flange. The driving key members 516 also function to align the second set of holes 506 with corresponding holes formed in the quill flange 502 when mounting a die subassembly onto the quill flange.

While several particular forms of the invention have been illustrated and described, it will also be apparent that various modifications can be made without departing from the scope of the invention. It is also contemplated that various combinations or subcombinations of the specific features and aspects of the disclosed embodiments can be combined with or substituted for one another in order to form varying modes of the invention. Accordingly, it is not intended that the invention be limited, except as by the appended claims.

What is claimed is:

1. A pelleting die assembly capable of being mounted on a quill of a pellet mill, the assembly comprising:
a die including an end surface for facing the quill;
a coupling member removably attached to the end surface; and
an attachment device extending through the coupling member, the attachment device for attaching the coupling member to the quill.

2. The assembly of claim 1, wherein the coupling member has a plurality of holes formed axially through the coupling member, the holes unobstructed by the die, and wherein the attachment device extends through the holes.

3. The assembly of claim 1, wherein end surface of the die has an inner edge and an outer edge, the outer edge located at a first radius, and the attachment device includes a plurality of bolts extending axially through the coupling member and located at a second radius greater than the first radius.

4. The assembly of claim 1, further comprising a second attachment device urging the coupling member into contact with the end surface of the die, the second attachment device located on a first radius on the coupling member, wherein the attachment device adapted to attach the coupling member to the quill is located at a second radius greater than the first radius.

5. The assembly of claim 1, wherein the coupling member is a flat disc having a quill facing side, a die facing side, and a plurality of holes formed through the coupling member, and wherein the attachment device includes a plurality of bolts, each bolt having threads adapted to engage the quill and a head adapted to push the quill facing side into contact with the quill.

6. The assembly of claim 1, wherein the coupling member includes first portion connected to the die, a second portion disposed around the first portion, and a third portion connecting the first and second portions together and adapted to allow the first and second portions to move relative to each other.

7. A pellet mill assembly comprising:
a quill;
a die; and
a coupling device connecting the die and the quill, the coupling device including a coupling member and an attachment device, the coupling member including a quill facing surface, the attachment device extending through the coupling member and pushing the quill facing surface into contact with the quill.

8. The assembly of claim 7, wherein the coupling member is an annular flat disc.

9. The assembly of claim 7, wherein the coupling member has flat sides facing opposite directions, one of the flat sides facing the die, the side facing the die including a first surface region and a second surface region, the first surface region covered by and in contact with the die, the second surface region being exposed and out of contact with the die.

10. The assembly of claim 7, wherein the coupling member is annular in shape and the quill has an annular groove formed in the quill, the annular groove sized to accept the coupling member.

11. The assembly of claim 7, wherein the coupling member is annular in shape, the die has an annular recess formed in the die and sized to receive a portion of the coupling member, and the quill has an annular groove formed in the quill and sized to receive the coupling member and a portion of the die.

12. The assembly of claim 7, wherein the coupling member includes end portions and a flexible linkage connecting the end portions, the flexible linkage adapted to allow the end portions to move relative to each other.

13. A pelleting die assembly comprising:
a die including a tubular wall defining a chamber inside the die, the tubular wall having two opposite ends, an inner surface, an outer surface, and a plurality of holes extending through the tubular wall;
a coupling ring removably attached to one of the opposite ends of the die, the ring having a first circumferential region and a second circumferential region surrounding the first circumferential region, the first circumferential covered by the die, the second circumferential region extending radially outward from the outer surface of the die; and
an attachment device extending axially through the second circumferential region.

14. The assembly of claim 13, wherein the first circumferential region is in contact with the die and the second circumferential region is out of contact with the die.

15. The assembly of claim 13, wherein the attachment device includes a plurality of bolts extending through the second circumferential region, each of the bolts having a head accessible from a die facing side of the coupling ring.

16. The assembly of claim 13, wherein the coupling ring includes at least one groove adapted to allow radial compression of the coupling ring.
